(19) United States
(12) Patent Application Publication
(10) Pub. No.: US 2005/0279553 A1
(43) Pub. Date: Dec. 22, 2005

(54) Apparatus and system for generating a reference signal indicating the speed of a railway or tramway vehicle

(75) Inventor: Roberto Tione, Lauriano (Torino) (IT)

Correspondence Address: SUGHRUE MION, PLLC, 2100 PENNSYLVANIA AVENUE, N.W., SUITE 800, WASHINGTON, DC, 20037, US

(73) Assignee: FAIVELEY TRANSPORT PIOSSASCO S.P.A.

(21) Appl. No.: 11/135,335

(22) Filed: May 24, 2005

(30) Foreign Application Priority Data
May 25, 2004 (IT) TO2004A000347

(51) Int. Cl. H02P 5/06

(52) U.S. Cl. 180/197

(57) ABSTRACT

The apparatus is designed to generate a reference signal indicating the speed of a railway or tramway vehicle provided with a braking system including a control system, in particular an anti-wheelslip control system associated with a group of wheels on the vehicle, comprising a group of speed sensors associated with corresponding wheels of said group and a control unit connected to said speed sensors and arranged to calculate by means of software according to pre-established procedures a reference speed indicating the speed of the vehicle. The apparatus comprises an analogue processing circuit arranged to generate by means of hardware, on the basis of the signals supplied by the above-mentioned speed sensors, a speed signal correlated to the speed of the vehicle. This circuit is connected at the output to the above-mentioned control unit, which is arranged to supply an enabling signal capable of allowing operational use of the speed signal supplied by said circuit only when the value of the speed indicated by this speed signal meets a predetermined comparison criterion in relation to the value of the reference speed calculated by means of software by the control unit.

The present invention relates to an apparatus for generating a reference signal indicating the speed of travel of a railway or tramway vehicle.

More specifically, the subject of the invention is an apparatus for a railway or tramway vehicle provided with an air-operated braking system, and including a control system, in particular an anti-wheelslip control system associated with a group of wheels on the vehicle, comprising a group of speed sensors associated with corresponding wheels of said group, and a control unit connected to said speed sensors and arranged to calculate, by means of software, according to pre-established procedures, a reference speed indicating the speed of travel of the vehicle.

In the field of railways, the problem arises of generating a signal indicating a reference speed of a vehicle which is “reliable”, with a view for example to enabling opening of the doors when the speed of the vehicle is less than a predetermined value. Other functions on a railway train also pre-suppose knowledge of a reference speed of the vehicle which is “reliable”.

Modern railway trains are provided with microprocessor-operated electronic control systems, for example anti-wheelslip control systems, and calculation by means of software of a reference speed indicating the speed of travel of the vehicle on the basis of the speed signals supplied by sensors associated with a group of wheels is relatively easy. Moreover, the guarantee that the speed signal is reliable is linked in such a case to the characteristics of the calculation software. The guarantee of quality/trustworthiness of such calculation software involves fairly high production costs, in particular in those railway applications which envisage the use of distributed control systems, which also inevitably involve network communications software.

A purpose of the present invention is to produce an apparatus which generates in a simple economical and reliable manner a signal indicating the speed of travel of a railway or tramway vehicle, with high reliability characteristics.

This and other purposes are achieved according to the invention with an apparatus of the type specified above, characterized in that it comprises

analogue processing circuit means arranged to generate by means of hardware, on the basis of the signals supplied by the above-mentioned speed sensors, a speed signal correlated to the speed of travel of the vehicle;

said analogue processing circuit means being connected at their output to the above-mentioned control unit, which is arranged to supply an enabling signal allowing operational use of the speed signal supplied by said analogue processing circuit means, only when the value of the speed indicated by said speed signal meets a predetermined criterion of comparison in relation to the value of the reference speed calculated by means of software by said control unit.

In the apparatus according to the invention, generation of the reference speed is performed by means of hardware, using processing circuits of the analogue type, and the parallel calculation by means of software of the reference speed carried out by the control unit arranged for the purpose serves only to verify the correctness of the speed signal generated by the analogue processing circuits, and where necessary to disable the use of this speed signal if it should present an anomalous value (fault condition).

The invention also relates to a system for generating a signal indicating the speed of travel of a railway or tramway vehicle comprising a plurality of groups of wheels with which is associated a corresponding plurality of apparatuses as defined above.

Other characteristics and advantages of the invention will become clear from the following detailed description which is given purely by way of non-limiting example, with reference to the appended drawings, in which:

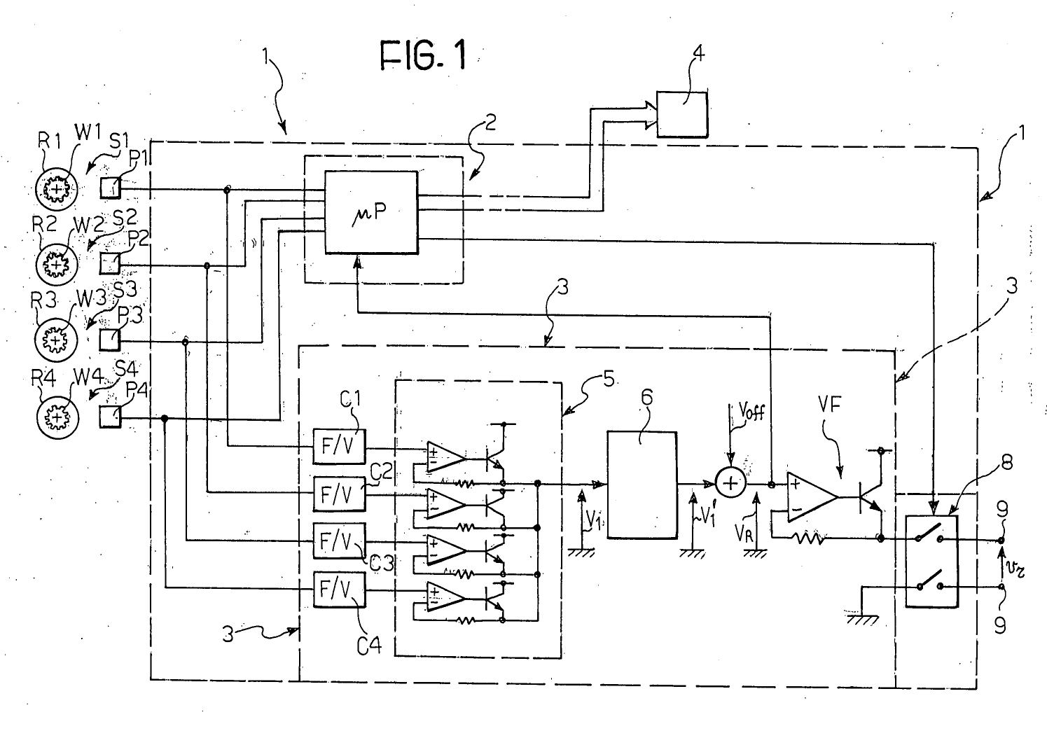

FIG. 1 is a circuit diagram, partly in block form, of an apparatus according to the present invention; and

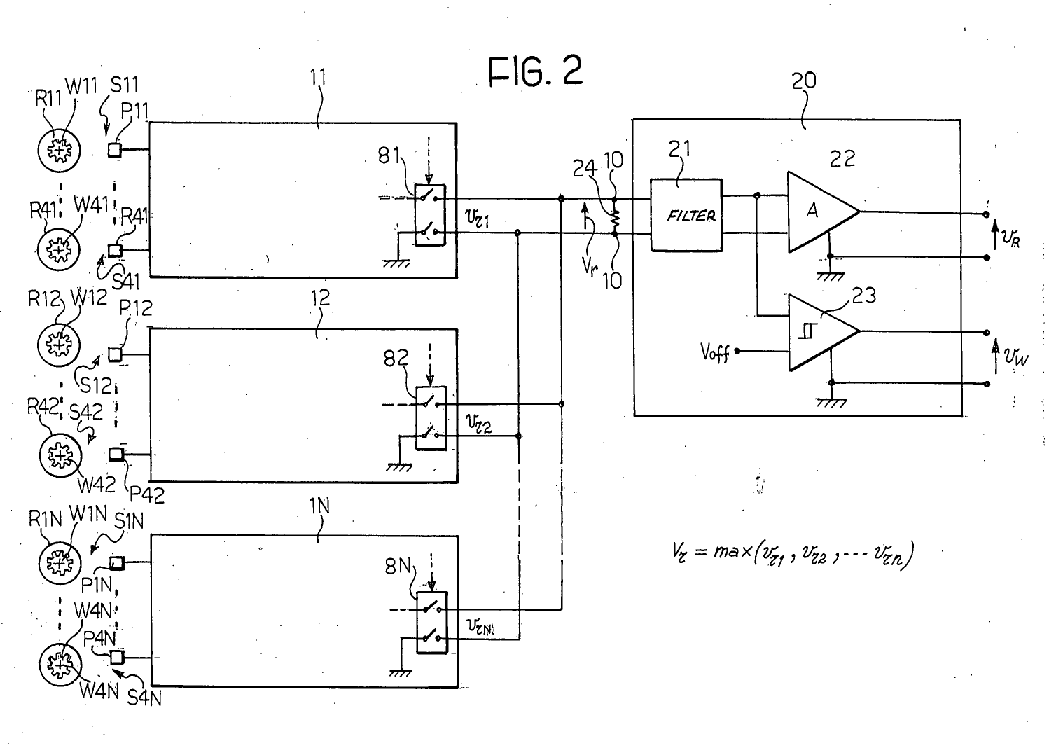

FIG. 2 is a block circuit diagram of a system according to the invention, comprising a plurality of apparatuses according to FIG. 1.

The number 1 in FIG. 1 indicates as a whole an apparatus according to the invention for generating a reference signal vᵣ indicating the speed of travel of a railway or tramway vehicle provided with an air-operated braking system and including a control system 2, in particular an anti-wheelslip control system associated with a group of wheels on the vehicle.

In a manner known in itself, the control system 2 comprises a plurality of speed sensors S1-S4, for example comprising respective magnetic or electromagnetic pickups P1-P4 associated with corresponding toothed wheels W1 capable of rotating in a synchronous manner with corresponding wheels R1-R4 on the vehicle.

In a manner known in itself, in operation the pickups of sensors S1-S4 supply the respective outputs with pulsed signals the frequencies of which indicate the speed of rotation of the wheels R1-R4 with which they are associated.

Sensors S1-S4 are connected to corresponding inputs of the control unit 2, implemented for example by the use of a microprocessor.

Sensors S1-S4 are also connected to the input of an analogue processing circuit indicated as a whole by the number 3 in FIG. 1. This circuit will be described in more detail in what follows.

The control unit 2 is arranged to analyse the signals supplied by sensors S1-S4, and to activate in a manner known in itself an anti-wheelslip function, controlling by means of electrically operated valve devices indicated as a whole by the number 4 the application, maintaining and release of braking pressure to the braking elements associated with the wheels.

The unit 2 is also arranged to calculate, by means of software, on the basis of the signals supplied by sensors S1-S4, a reference speed indicating the speed of travel of the vehicle.

The analogue processing circuit 3 comprises a plurality of frequency/voltage converters C1-C4, connected in due order to the outputs of pickups P1-P4 of sensors S1-S4.

The outputs of converters C1-C4 are connected in due order to corresponding inputs of a selection circuit indicated as a whole by the number 5, arranged to supply at its output a signal V₁ corresponding to the highest-value signal among those present at the outputs of said converter circuits C1-C4.

In the embodiment illustrated by way of example, the circuit 5 comprises four voltage-follower circuits, of a structure known in itself, the outputs of which are connected in parallel with each other to form the total output of this circuit 5.

The voltage V₁ available at the output of the circuit 5 therefore indicates the highest speed value among the values indicated by the signals supplied by sensors S1-S4.

The output of circuit 5 is connected to the input of a limiter circuit 6. This circuit is arranged to limit the negative value of the derivative of the speed indicated by the signal V₁ to a predefined value, substantially equal to the maximum deceleration permitted for the railway or tramway vehicle.

The circuit 6 has one of the various circuit structures known in themselves, and its output is connected to an input of an analogue summing circuit 7. This summing circuit 7 adds to the voltage V₁′ which is present at the output from the limiter circuit 6 an offset voltage V_{off} having a predetermined constant value.

The voltage V_{R} at the output of the summing circuit is on the one hand applied to a voltage follower circuit VF being the output of the analogue processing circuit 3, and on the other is supplied to an input of the control unit 2 described previously.

The control unit 2 is arranged to compare the value of the speed of travel of the vehicle indicated by the voltage V_{R} with the reference speed value calculated correspondingly by means of software by the unit 2.

If the speed indicated by the voltage V_{R} falls within a pre-established range relative to the value calculated by means of software by the unit 2, this unit by means of a controlled switching device 8 connects the output of the analogue processing circuit 3 to output terminals 9 of the apparatus 1, enabling the voltage V_{R} to be used, for example to give permission for opening the doors of the railway carriage when the signal V_{R} indicates the fact that the speed of travel of the carriage is less than a predetermined value.

If instead the speed indicated by the voltage V_{R} differs relative to the speed calculated by means of software by the unit 2 to an extent greater than a predefined amount, the unit 2 disconnects by means of the switching device 8 the output terminals 9 from the output of the analogue processing circuit 3, thereby disabling the use of the reference speed signal generated by this analogue processing circuit.

FIG. 2 shows a system for generating a signal v_{R} indicating the speed of travel of a railway vehicle comprising a plurality of groups of wheels, R11-R41, R12-R42, . . . , R1N-R4N, with each of which is associated a respective control system including a corresponding group of speed sensors S11-S41, S12-S42, . . . , S1N-S4N.

With each of the above-mentioned groups of wheels is associated a respective apparatus 11, 12, . . . , 1N, each of which has a structure such as that of the apparatus 1 described previously with reference to FIG. 1.

The outputs of the apparatuses 11, 12, . . . , 1N are connected to each other substantially in parallel, in such a way that at the common output represented by the terminals indicated by the number 10 in FIG. 2 there is present operationally a voltage V_{R} which has the highest value among the output voltages v_{R1}, v_{R2}, . . . , v_{RN} available at the outputs of the various apparatuses 11, 12, . . . , 1N.

The common output 10-10 of the apparatuses 11, 12, . . . , 1N is connected to the input of a receiver device indicated as a whole by the number 20 in FIG. 2. This device comprises substantially an input filter 21, intended to filter out noise, the output of which is connected to the input of an amplifier 22.

In operation, a voltage v_{R} indicating the speed of travel of the vehicle is available at the output of the amplifier 22.

The signal at the output of the filter 21 is compared with the offset voltage V_{off} by means of a threshold comparator 23 comprised in the receiver device 20. This comparator supplies as its output a warning voltage V_{W} when the signal at the input of the amplifier 22, which corresponds substantially to the voltage V_{R}, becomes less than the offset voltage V_{off}.

If the unfortunate case should occur that all the apparatuses 11, 12, . . . , 1N are in the fault condition, that is if all the associated switches 81, 82, . . . , 8N are forced to the open condition, a resistor 24 (FIG. 2) arranged in parallel between the terminals 10 actually cancels the voltage at the input of the filter 21 and therefore to the inputs of the amplifier 22 and of the comparator 23, in particular forcing the latter to be switched to the state corresponding to the presence of the warning voltage V_{W}.

Naturally, the principle of the invention remaining the same, the forms of embodiment and details of construction may be varied widely with respect to those described and illustrated, purely by way of non-limiting example, without thereby departing from the scope of the invention as defined in the appended claims.

1. An apparatus for generating a reference signal indicating the speed of travel of a railway or tramway vehicle provided with an air-operated braking system including a control system, in particular an anti-wheelslip control system associated with a group of wheels on the vehicle, comprising a group of speed sensors associated with corresponding wheels of said group and a control unit connected to said speed sensors and arranged to calculate by means of software according to pre-established procedures a reference speed indicating the speed of travel of the vehicle;
the apparatus also comprising
analogue processing circuit means arranged to generate by means of hardware, on the basis of the signals supplied by the above-mentioned speed sensors, a speed signal correlated to the speed of travel of the vehicle;
said analogue processing circuit means being connected at the output to said control unit, which is arranged to supply an enabling signal allowing operational use of the speed signal supplied by said analogue processing circuit means, only when the value of the speed indicated by said speed signal meets a predetermined comparison criterion in relation to the value of the reference speed calculated by means of software by said control unit.

2. An apparatus according to claim 1, in which said analogue processing circuit means comprise a selection circuit connected at its input to all the above-mentioned speed sensors (S1-S4) of said group, and capable of supplying as output a speed signal indicating the highest speed value among the values indicated by the signals supplied by said sensors.

3. An apparatus according to claim 2, in which the output of said selection circuit is connected to a limiter circuit capable of limiting the negative value of the derivative of the speed indicated by the output signal of said selection circuit to a value substantially equal to the maximum deceleration permitted for the vehicle.

4. An apparatus according to claim 3, in which the output of the limiter circuit is connected to a summing device capable of adding to the signal coming from the limiting circuit a constant offset voltage of predetermined value.

5. An apparatus according to claim 1, comprising an output connected to the output of said analogue processing circuit means by switching means driven by said control unit.

6. A system for generating a signal indicating the speed of travel of a railway or tramway vehicle comprising a plurality of groups of wheels with each of which is associated a respective control system including a corresponding group of speed sensors associated with the wheels and connected to a corresponding control unit arranged to calculate by means of software a reference speed indicating the speed of travel of the vehicle; the system being characterized in that with each group of wheels is associated a respective apparatus according to claim 1, the outputs of said apparatuses being connected to a common output in such a way that the signal with the highest value among the signals available at the outputs of said apparatuses is applied operationally to said common output.

7. A system according to claim 6, in which said common output is connected to a filter followed by an amplifier.

8. A system according to claim 6, comprising a threshold comparator capable of generating a warning signal when the signal available at said common output is less than a threshold voltage substantially equal to the above-mentioned offset voltage.

9. A system according to claim 8, in which a resistor is connected in parallel with said common output.
